(19) United States
(12) Patent Application Publication
(10) Pub. No.: US 2006/0059784 A1
(43) Pub. Date: Mar. 23, 2006

(54) Door module positioning system

(76) Inventors: Eluid David Carter, Southfield, MI (US); Everardo A. Hernandez, Shelby Township, MI (US); Santhosh Kumar Karumuri, Inkster, MI (US); Bryan Thomas Smith, Royal Oak, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/946,019

(22) Filed: Sep. 21, 2004

(51) Int. Cl. B60J 5/04

(52) U.S. Cl. 49/502

(57) ABSTRACT

A door module assembly includes a door module panel having a plurality of locating pins. An inner door panel includes a plurality of openings that cooperate with the plurality of locating pins to align the door module panel relative to the inner door panel and to retain the door module panel on the inner door panel without requiring fasteners. The plurality of plurality of locating pins is orientated obliquely relative to the door module panel with each one of the plurality of locating pins being received within one of the openings, which extend obliquely relative to the inner door panel. At least one door module component, such as a window lift mechanism or door lock mechanism, for example, is mounted to the door module panel independently from the plurality of locating pins.

### TECHNICAL FIELD

The subject invention relates to a door module positioning system with an inclined locating pin surface that allows a door module panel to be initially supported and retained on an inner door panel during assembly without requiring fasteners.

### BACKGROUND OF THE INVENTION

Door module assemblies include a door module panel that supports components such as door locks and window lifters, for example. The door module panel is attached to an inner door panel on a vehicle door. Typically, a door module assembly includes locating pins that extend outwardly from one side of the door module panel. The locating pins are inserted into openings formed in the inner door panel to align the door module panel relative to the inner door panel.

Traditionally, each locating pin is perpendicular to the door module panel. Corresponding openings extend perpendicularly into one side of the inner door panel. One disadvantage with this configuration is that the door module panel must be immediately fastened to the inner door panel to retain the door module panel to the inner door panel. Thus, the locating pins alone cannot be used to retain the door module panel to the inner door panel.

This perpendicular orientation of the locating pins could result in the door module panel sliding away and separating from the inner door panel if the door module panel and inner door panel are not immediately fastened together after alignment. This means that the alignment and attachment steps must be performed at the same assembly line station. This makes assembly more difficult and expensive.

Thus, there is a need for a door module positioning system that uses a common feature to both locate and retain the door module panel and inner door panel together. Further, this common feature should not require immediate permanent attachment between the door module panel and the inner door panel to allow the door module assembly to be moved between assembly line stations or to have additional assembly steps performed prior to permanent attachment, as desired.

### SUMMARY OF THE INVENTION

A door module assembly includes a door module panel and an inner door panel. At least one locating pin extends outwardly from one of the door module panel or inner door panel towards the other of the door module panel or inner door panel. The at least one locating pin aligns and retains the door module panel and inner door panel together.

In one example, the locating pin extends outwardly from the door module panel and is received within a corresponding opening formed within the inner door panel. The at least one locating pin aligns the door module panel relative to the inner door panel and retains the door module panel on the inner door panel without requiring fasteners or additional attachment steps. The at least one locating pin extends at an oblique angle relative to a side surface of the door module panel. The corresponding opening extends at an oblique angle relative to the inner door panel. The at least one locating pin is received within the corresponding opening to achieve alignment and retention.

In one example, the door module panel includes a raised support surface formed on one side of the door module panel. The raised support surface includes an inclined portion that extends obliquely relative to the door module panel. The at least one locating pin extends outwardly from the inclined portion. The at least one locating pin extends generally perpendicular relative to the inclined portion.

At least one door module component is mounted to the door module panel independently from the at least one locating pin. The at least one door module component includes at least one of a window lift mechanism or door lock mechanism.

By using locating pins for alignment and retention of the door module panel on the inner door panel, panel separation is avoided and subsequent assembly steps can be performed without requiring permanent attachment of the door module panel to the inner door panel. Permanent attachment can then occur subsequent to any desired assembly operations. These and other features of the present invention can be best understood from the following specification and drawings, the following of which is a brief description.

### BRIEF DESCRIPTION OF THE DRAWINGS

FIG. 1 is a schematic side view of a door module assembly incorporating the subject invention.

FIG. 2 is a perspective view of a door module panel incorporating the subject invention.

FIG. 3 is a magnified view of one locating pin as shown in FIG. 2.

FIG. 4 is a schematic view of an inner door panel as used with the subject invention.

FIG. 5 is a side cross-sectional view of the inner door panel and door module panel with an installed locating pin.

### DETAILED DESCRIPTION OF THE PREFERRED EMBODIMENT

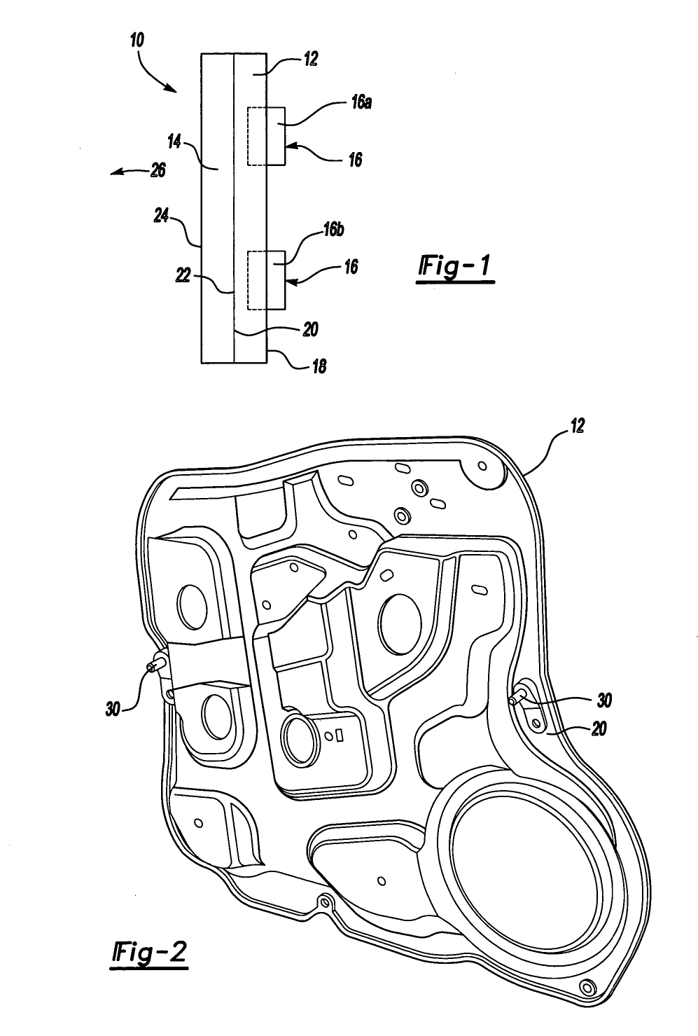

A door module assembly 10 is shown schematically in FIG. 1. The door module assembly 10 includes a door module panel 12 and an inner door panel 14. Door module components 16 are mounted to the door module panel 12. The door module components 16 can be any type of known door module component such as a window lifter mechanism 16a or a door lock mechanism 16b, for example.

The door module panel 12 includes an outer surface 18 and an inner surface 20 that faces the inner door panel 14. The inner door panel 14 includes an outer surface 22 that faces the door module panel 12 and an inner surface 24 that faces towards a passenger compartment. Location of the passenger compartment is generally indicated by arrow 26.

At least one locating pin 30 extends outwardly from one of the door module panel 12 or inner door panel 14 towards the other of the door module panel 12 or inner door panel 14. In the example shown in FIG. 2, a pair of locating pins 30 extends from the inner surface 20 of the door module panel 12 toward the outer surface 22 of the inner door panel 14. Each locating pin 30 extends obliquely relative to the inner surface 20 of the door module panel 12. In the example shown in FIG. 2, the door module panel 12 includes two (2) locating pins 30, however, it should be understood that additional locating pins may be used or only a single locating pin may be required depending upon size, weight, and/or any other known door module characteristics or specifications.

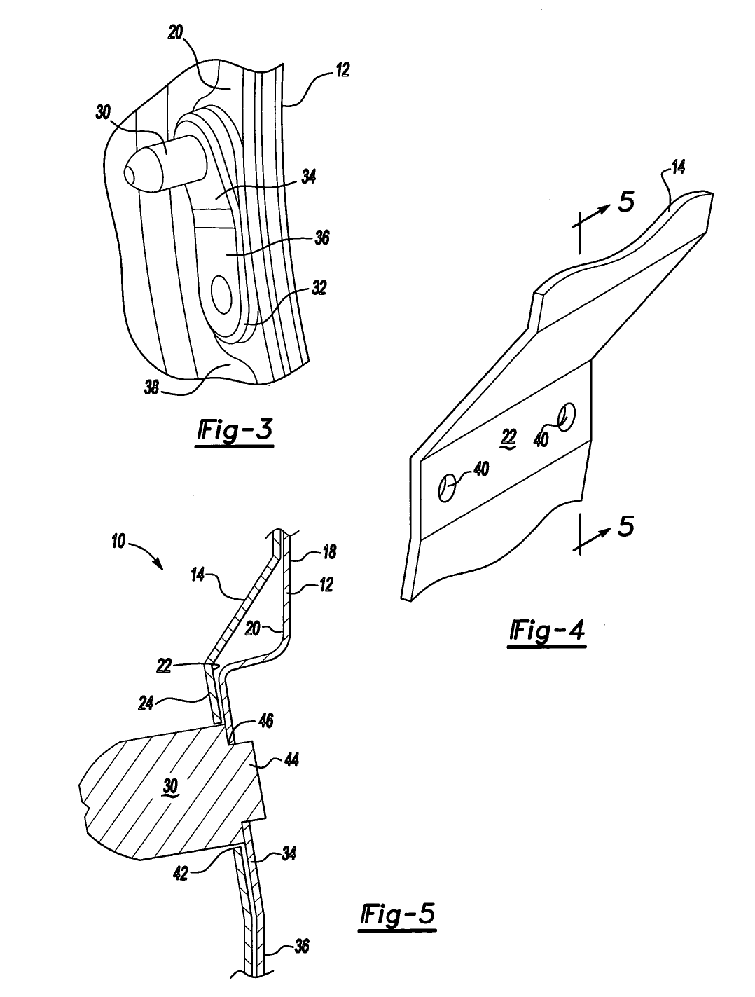

An oblique orientation of the locating pins 30 can be achieved in many different ways. In the example shown in FIG. 3, each locating pin 30 extends from a raised support portion 32 formed on the inner surface 20 of the door module panel 12. In this example, the raised support portion 32 includes an inclined surface portion 34 and a flat surface portion 36. The inclined surface portion 34 extends obliquely relative to flat surface portion 36, which is generally parallel to a vertically extending surface 38 formed on the inner surface 20 of the door module panel 12. In one example, the inclined surface portion 34 is formed at a ten degree incline relative to the flat surface portion 36, however other angles could also be used. The locating pin 30 extends outwardly from the inclined surface portion 34 toward the inner door panel 14. The locating pin 30 preferably extends perpendicular to the inclined surface portion 34.

The inner door panel 14, shown in FIG. 4, includes a plurality of openings 40 that correspond in number to the desired number of locating pins 30. Each opening 40 is formed in the outer surface 22 of the inner door panel 14 and extends inwardly toward the inner surface 24 of the inner door panel 14 to form longitudinally extending recesses 42 (only one is shown), shown in FIG. 5. The longitudinally extending recesses 42 extend obliquely relative to a vertically extending surface portion 44 formed on the outer surface 22 of the inner door panel 14.

The locating pins 30 can be integrally formed with the door module panel 12 or can be separate pieces. As shown in FIG. 5, each locating pin 30 is installed into the door module panel in an interference fit. The locating pin 30 includes a reduced diameter portion 44 that is received within an opening 46 formed in the door module panel 12.

The oblique orientation of the locating pins 30 and the recesses 42 provide both alignment and retention capability for the door module assembly 10. The locating pins 30 and recesses 42 cooperate to align the door module panel 12 relative to the inner door panel 14. The locating pins 30 and recesses 42 are angled from vertical to act as “hooks” to retain the door module panel 12 to the inner door panel 14. Panel separation is avoided and subsequent assembly steps can be performed without requiring permanent attachment of the door module panel 12 to the inner door panel 14. Permanent attachment between the door module panel 12 and the inner door panel 14 can then occur subsequent to any desired assembly operations. Door module components 16 are mounted to the door module panel 12 independently from the locating pins 30. This mounting of the door module components 16 can occur before, during, or after permanent attachment occurs between the door module panel 12 and the inner door panel 14.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A door module assembly comprising:
a door module panel mountable to an inner door panel; and
one of a locating pin or an opening formed on said door module panel to cooperate with the other of the locating pin and opening formed on the inner door panel, such that there is a retention feature wherein the locating pin is received in the opening to align said door module panel relative to the inner door panel with said retention feature retaining said door module panel on the inner door panel without requiring additional mounting components.

2. The door module assembly according to claim 1 wherein the locating pin extends from said door module panel, and the opening is formed in the inner door panel.

3. The door module assembly according to claim 2 wherein said retention feature comprises positioning the locating pin obliquely relative to a side surface of said door module panel.

4. The door module assembly according to claim 3 wherein the inner door panel is supported on the door module panel with the opening extending obliquely relative to a panel surface of the inner door panel.

5. The door module assembly according to claim 3 including a raised support surface extending outwardly from said side surface wherein said raised support surface includes an inclined portion and a flat portion, said inclined portion extending obliquely relative to said flat portion with said flat portion extending generally parallel relative to a vertically extending side surface on said door module panel.

6. The door module assembly according to claim 5 wherein the locating pin extends outwardly from said inclined portion.

7. The door module assembly according to claim 3 including at least one door module component mounted to said door module panel independently from the locating pin.

8. The door module assembly according to claim 7 wherein said at least one door module component includes at least one of a door lock mechanism and a window lift mechanism.

9. A door module assembly comprising:
a door module panel having an inner module surface and an outer module surface facing opposite from said inner module surface;
an inner door panel having an inner panel surface and an outer panel surface facing said inner module surface;
a plurality of raised support surfaces formed on said inner module surface;
a plurality of locating pins extending from said inner module surface with one of said plurality of locating pins extending outwardly from each of said raised support surfaces at an oblique angle relative to said inner module surface; and
a plurality of openings formed within said inner door panel and open to said outer panel surface wherein said plurality of locating pins cooperates with said plurality of openings to align said door module panel relative to said inner door panel and to retain said door module panel on said inner door panel without requiring additional mounting components.

10. The door module assembly according to claim 9 wherein each of said plurality of raised support surfaces includes an inclined portion extending obliquely relative to a vertically extending side surface of said door module panel with one of said plurality of locating pins extending from each of said inclined portions.

11. The door module assembly according to claim 10 wherein each of said plurality of openings extends obliquely relative to said outer panel surface.

12. The door module assembly according to claim 11 including at least one door module component mounted to said door module panel independently from said plurality of locating pins.

13. The door module assembly according to claim 10 wherein each of said plurality of locating pins is perpendicular to a respective inclined portion.

14. A method of attaching a door module panel to an inner door panel comprising:
(a) aligning the door module panel relative to the inner door panel with at least one locating pin; and
(b) retaining the door module panel on the inner door panel with the at least one locating pin without requiring additional mounting components.

15. The method according to claim 14 including orientating the at least one locating pin at an oblique angle relative to an inner module surface of the door module panel.

16. The method according to claim 15 wherein steps (a) and (b) are simultaneously performed by inserting the at least one locating pin into a corresponding at least one oblique opening formed within an outer panel surface of the inner door panel.

17. The method according to claim 16 wherein steps (a) and (b) are performed during a first assembly operation; and
including (c) performing at least one subsequent assembly operation after steps (a) and (b); and
then (d) fastening the door module panel to the inner door panel subsequent to step (c) at locations remote from the at least one locating pin.

18. The method according to claim 16 including mounting at least one door module component to the door module panel independently from the at least one locating pin.

19. The method according to claim 18 wherein the at least one door module component includes at least one of a window lift mechanism or door lock mechanism.
